(19) United States
(12) Patent Application Publication
(10) Pub. No.: US 2013/0033426 A1
(43) Pub. Date: Feb. 7, 2013

(54) HANDHELD PROJECTOR AND PROJECTION METHOD THEREOF

(71) Applicants: Yu-Lin Wang, New Taipei City (TW); Wei-Hung Chen, Shanghai (CN)

(72) Inventors: Yu-Lin Wang, New Taipei City (TW); Wei-Hung Chen, Shanghai (CN)

(73) Assignees: INVENTEC APPLIANCES (PUDONG) CORPORATION, Shanghai (CN); INVENTEC APPLIANCES (SHANGHAI) CO.,LTD., Shanghai City (CN); INVENTEC APPLIANCES CORP., New Taipei City (TW)

(21) Appl. No.: 13/565,758

(22) Filed: Aug. 2, 2012

(30) Foreign Application Priority Data
Aug. 4, 2011 (CN) 201110223127.6

(51) Int. Cl. G09G 5/08

(52) U.S. Cl. 345/157

(57) ABSTRACT

The invention provides a handheld projector and a projection method thereof. The handheld projector includes a projection module, a control module, a detecting module and a steering module. The control module drives the projection module to project an image towards an object, which includes a cursor. The detecting module generates a shift signal according to shift of the handheld projector, and transmits the shift signal to the control module. The control modules drives the steering module to rotate the projection module towards an opposite direction of the shift of the handheld projector, so as to make the image projected by the projection module stay in a fixed position of the object. Through the invention, projected image is not easily shocked, and the user only need move the handheld projector when change of the cursor position is desired, and thus operation convenience is greatly enhanced.

### CROSS-REFERENCE TO RELATED APPLICATION

This application claims the priority benefit of China application serial no. 201110223127.6, filed on Aug. 4, 2011. The entirety of the above-mentioned patent application is hereby incorporated by reference herein and made a part of this specification.

### BACKGROUND OF THE INVENTION

1. Field of the Invention

The invention relates to a handheld projector and a projection method thereof. Particularly, the invention relates to a handheld projector which is able to detect shift of the handheld projector and then automatically adjusts a projection angle and the projection image. The invention is also relates to a projection method of the handheld projector.

2. Description of Related Art

In the past, when people are delivering speech or participating a meeting, a slide projector is often used to present the enlarged image so as to enable the viewers watch the image within a certain distance, and thereby making the viewers participate in depth into the speech or the meeting. In recent years, with development of digital technology and microelectronics, digital projectors (abbreviated as a projection apparatus) have gradually replaced the conventional slide projector, and thus becomes a main stream product in this field. The type of project apparatus can be connected with other electronic apparatuses (such as calculators, DVD player, or gaming consoles, and so like) through its connectors and connecting cables. When the projection apparatus receives image signals, through calculation programs of encoding and decoding and its projection lens and projection source, the image is projected unto a surface of an object such as a wall or a projection screen, so as to make viewers and the user conveniently watch the projected image. Further, in order to meet visual and audio requirements of the user, some vendors add components of audio equipments in the projection apparatus so as to make the projection apparatus have audio output functionality. When the electronic device transmits audio signals to the projection apparatus through the connecting cable, this type of projection apparatus can then play audio signals at the same time when projecting the image.

In view of the aforementioned descriptions, regarding operation methods of the projection apparatus, the user can usually place the projection apparatus on the table, or hang the projection apparatus to the ceiling, so as to fix the projection apparatus. As such, the projected image from the projection apparatus can stay in a fixed position without any swaying or shifting situations. Apart from aforementioned large size projection apparatus, there are also handheld projectors developed some vendors, where the volume of the handheld projector is far less than the conventional projection apparatus, and the weight of the handheld projector is far less than the conventional projection apparatus. The user can hold this kind of handheld projector and project images to required position according to practical requirements. However, in comparison with the conventional projection apparatuses, when the user is operating the handheld projector, the user holds the handheld projector by hand. Thus, the user may sway the hand during the projection, and this accordingly may not only cause shaking of image but also make the user or other viewers more unable to clearly recognize the image. Also, other viewers may also feel uncomfortable due to swaying of the projected image, and this leads to unexpected effects. On the other hand, if the user wishes to maintain stability of the image by maintaining the hand posture, fatigue of the user may be greatly increased, and this may prevent the user from operating the handheld projector for a long duration.

Moreover, currently, in a normal handheld projector, there may be disposed a plurality of buttons such as direction button(s), a confirmation button and so like. When the user projects an image including a menu or a light cursor on an object by the handheld projector, the user may control the light cursor by pressing the aforementioned direction button(s) to move the light cursor to position required by the user. However, when the user presses the button, the handheld projector may be swayed, thereby causing the aforementioned image shaking problem and leading to unexpected effects. Further, when the manufacturers design the handheld projector, sometimes it is required to dispose a plurality of buttons, and this situation not only make the application interface and hardware structure of the handheld projector more complicated, but also increase design and manufacturing cost, thereby leading to disadvantaged effects.

Therefore, it is an important issue on how to improve various known problems of the handheld projector, so as to avoid image swaying situation occur when the user operates the handheld projector, and decrease the number of buttons of the handheld projector, thereby simplifying the design of the handheld projector, making the user intuitively operate the handheld projector and enhancing operation convenience thereof.

### SUMMARY OF THE INVENTION

In view of the aforementioned descriptions, through long time research and experiments, the inventor has developed and designed a handheld projector and a projection method for the handheld projector of the invention, which may avoid shaking of image due to swaying of the handheld projector, prevent the viewer from uncomfortable feeling when viewing the image, and thereby enhancing operation convenience of the handheld projector.

According to one aspect of the invention, the invention provides a handheld projector which includes a control module, a projection module, a detecting module and a steering module. The projection module is electrically connected to the control module, and the control module is configured to drive the projection module to project an image towards an object, and the image includes a cursor. The detecting module is electrically connected to the control module and configured to generate a shift signal according to shift of the handheld projector, and the detecting module transmits the shift signal to the control module. The steering module is respectively and electrically connected to the control module and the projection module. After the control module receives the shift signal, the control module generates a rotation command according to the shift signal, and then transmits the rotation command to the steering module to drive the steering module to rotate the projection module towards an opposite direction of the shift of the handheld projector, so as to make the image projected by the projection module stay in a fixed position of the object. The control module generates a cursor movement command according to the shift signal to drive the projection module to change a position of the cursor when projecting the image, thereby achieving an effect of moving the light cursor.

Preferably, the handheld projector further includes a distance measuring module electrically connected to the control module and configured to detect a projection distance between the handheld projector and the object, and then transmit data of the projection distance to the control module. Accordingly, the projection distance may be used to accurately control the steering module.

Preferably, the control module of the handheld projector calculates a shift distance Y of the handheld projector according to the shift signal, calculates a deviation angle θ1 through a first mathematical expression of “tanθ1=X÷Y ” according to a projection distance X, and further calculates a steering angle θ2 through a second mathematical expression of “θ2=90°-θ1”, wherein the control module generates the rotation command according to the steering angle θ2, and makes the steering module to rotate the projection module according to the steering angle θ2.

Preferably, the detecting module is a gyroscope, an accelerometer or a G-Sensor.

According to another aspect of the invention, the invention provides a projection method for a handheld projector, which may be applied on a handheld projector. The handheld projector includes a projection module, a control module, a detecting module, and a steering module. The projection method for a handheld projector includes following steps. An image is projected towards an object by the projection module, wherein the image comprises a cursor. A shift signal is obtained according to shift of the handheld projector. A rotation command is generated according to the shift signal for rotating the projection module, so as to make the image projected by the projection module stay in a fixed position of the object. A cursor movement command is generated according to the shift signal to change a position of the cursor when projecting the image according to the shift signal.

Preferably, the projection method for a handheld projector further includes step of obtaining a projection distance between the handheld projector and the object.

Preferably, the projection method for a handheld projector further includes step of calculating a displacement distance Y of the handheld projector according to the shift signal; calculating a deviation angle θ1 according to the projection distance X and a first mathematical expression of “tanθ1=X÷Y ”; calculating a steering angle θ2 according to a second mathematical expression of “θ2=90°-θ1”; and generating the rotation command according to the steering angle θ2, and rotating the projection module according to the steering angle θ2.

When applying the handheld projector and the projection method thereof, even the user accidentally sway the handheld projector, the image can still be stably projected in fixed position, and thus uncomfortable feeling caused by shaking of image is avoided. Further, the user only need to move the handheld projector, and then the light cursor is move, thereby greatly decreasing opportunities of pressing the buttons. Also, when the manufacturers design the handheld projector, some buttons may also be omitted, and this can lead to more simplified design of the handheld projector. Under the condition that the stability of image can still be maintained, the position of the light cursor can be moved at the same time, and this may lead to great operation convenience.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a functional block diagram of a handheld projector according to a preferred embodiment of the invention.

FIG. 2 illustrates a functional block diagram of a handheld projector according to a preferred embodiment of the invention.

FIG. 3 illustrates a schematic diagram of a projected image by using the invention.

FIG. 4 illustrates another schematic diagram of a projected image by using the invention.

FIG. 5 illustrates a schematic diagram of a operation principle of the invention.

FIG. 6 illustrates a flowchart of a projection method of a handheld projector according to a preferred embodiment of the invention.

### DETAILED DESCRIPTION OF DISCLOSED EMBODIMENTS

In long term of researching and design in related field of the projector apparatuses, the inventor discovers that when the user operates familiar handheld projector, the user usually sways the handheld projector accidentally, which may cause shaking of the image projected by the handheld projector, and thereby affecting the visual effects of the projected image, and this is not an ideal situation. Further, the user may need to press buttons of the handheld projector to control the light cursor on the menu. However, the conventional handheld projector is lack of intuitive operation, and it is not convenient in operating the conventional handheld projector. In view of the aforementioned problems, the inventor thinks of using a detecting module and a steering module to come up with a design of a handheld projector which may automatically adjusts the projection angle, so as to solve one of the known problems, and thereby enhancing operation convenience of the handheld projector.

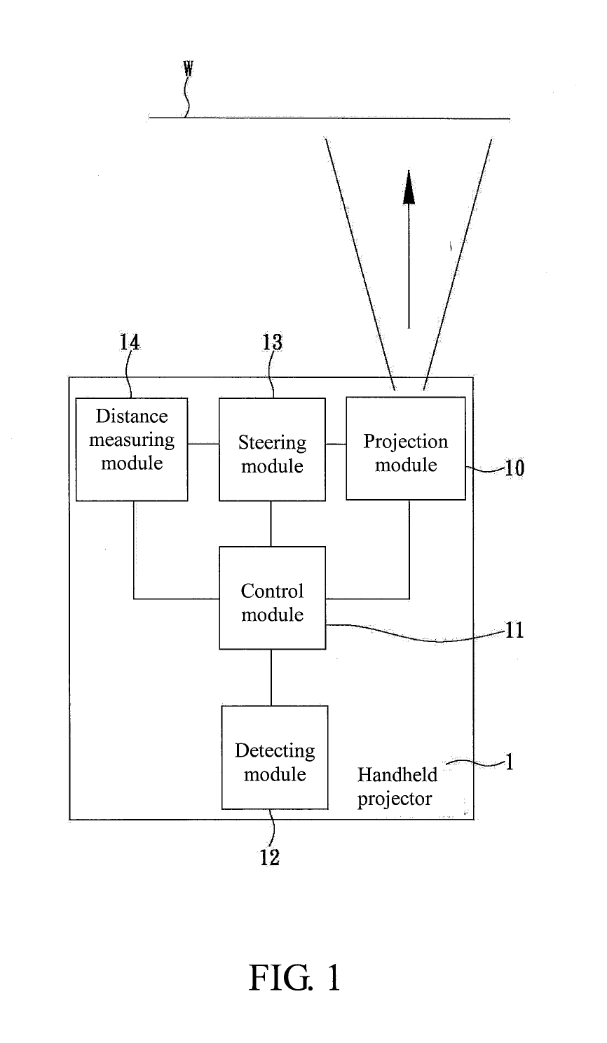

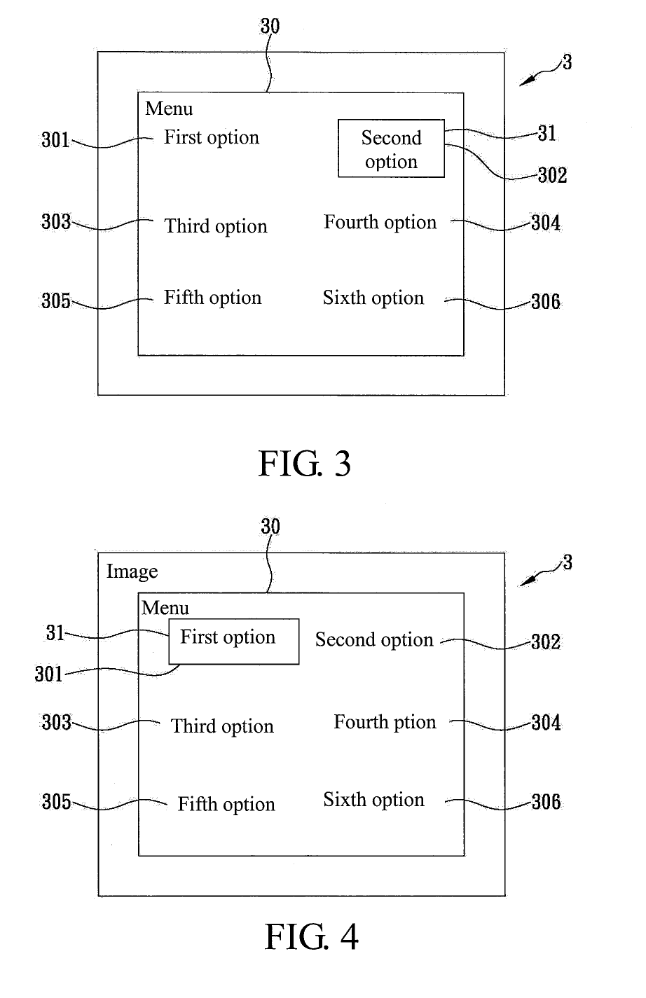

The invention relates to a handheld projector and a projection method thereof. As shown in FIG. 1, in a preferred embodiment of the invention, a handheld projector 1 mainly includes a projection module 10, a control module 11, a detecting module 12 and a steering module 13. The projection module 10 is electrically connected to the control module 11. In a preferred embodiment of the invention, the projection module 10 comprises projection lens and a projection light source. The control module 11 can drive the projection module 10 to project an image 3 (as shown in FIG. 3) towards an object W. In a preferred embodiment of the invention, the object W can be a flat and smooth surface of a wall or a projection screen. When the image 3 is projected unto the object W, the user and other viewers can watch the image 3 on the object W.

As shown in FIG. 3, the image 3 of the present embodiment may include a light cursor 31, where the light cursor 31 is displayed as a squared box. In fact, the light cursor 31 may be designed as different forms according to practical design requirements. Further, the image 3 may also include a menu 30, and a plurality of options 301-306 may be displayed on the menu 30. The options 301-306 may be respectively a first option 301, a second option 302, a third option 303, a fourth option 304, a fifth option 305 and a sixth option 306. In practical applications, the options 301-306 may be different language options (for example, Chinese, English, German, and so like). However, the aforementioned options are merely examples and the invention is not limited thereto. As shown in FIG. 1 and FIG. 3, before the handheld projector 1 is shifted accidentally by the user, the user selects the second option 302 on the menu 30 with the light cursor 31. Moreover, as shown in FIG. 1, in the present preferred embodiment, the detecting module 12 is a gyroscope, which is an apparatus configured to detect and maintain direction(s) and is mainly designed based on conservation of angular momentum. However, the present invention is not limited thereto. When manufacturers design the handheld projector 1 according to concepts of the present invention, the detecting module 12 may also include other components which are configured to detect physical movements such as accelerometers or gravitation sensors (G-Sensors). The modifications and variations which may be easily come up from those skilled in the art still fall within the scope of the claims of the present invention and their equivalents.

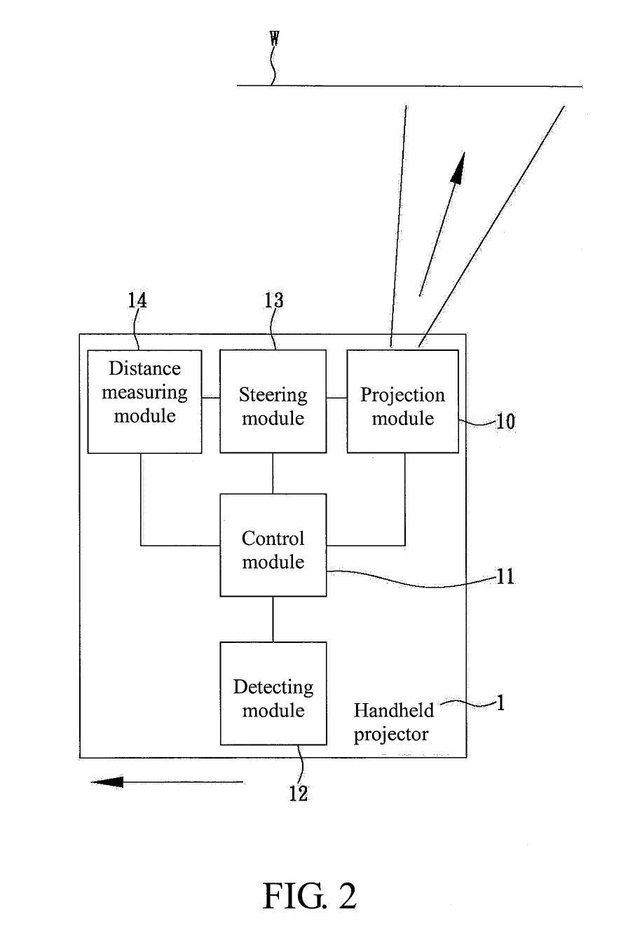

As shown in FIG. 2, the detecting module 12 is electrically connected to the control module 11. In FIG. 2, it is assumed that the handheld projector 1 is shifted to the left (or an anti-clockwise rotation) by the user accidentally, and the detecting module 12 generates a shift signal according to a shift direction and a shift distance and then transmits the shift signal to the control module 11. The steering module 13 is respectively electrically connected to the control module 11 and the projection module 10. In the present preferred embodiment, the steering module 13 may be a rotation motor, but the present invention is not limited thereto. It is noted that the steering module 13 can be implemented by other components. After the control module 11 receives the shift signal, the control module 11 generates a rotation command according to the shift signal. Then, the steering module 11 further transmits the rotation command to the steering module 13 to drive the steering module 13 to rotate the projection module 10 towards an opposite direction (or in a clockwise rotation) of the shift of the handheld projector 1, so as to make the image 3 (shown in FIG. 4) projected by the projection module 10 stay in a fixed position of the object W.

Further, as shown in FIG. 1 and FIG. 3, before the handheld projector 1 is shifted by the user, the user selects the second option 302 on the menu 30 with the light cursor 31. In order to achieve moving the light cursor 31, the control module 11 may generate a light cursor command according to the shift signal. Thus, the projection module 10 changes the position of the light cursor 31 according to the light cursor command when the projection module 10 projects the image 3, as shown in FIG. 2 and FIG. 4. Since in the present preferred embodiment, the handheld projector 1 is shifted towards left by the user, the light cursor 31 is moved to the left according to the light cursor command, so as to select the first option 301 on the menu 30.

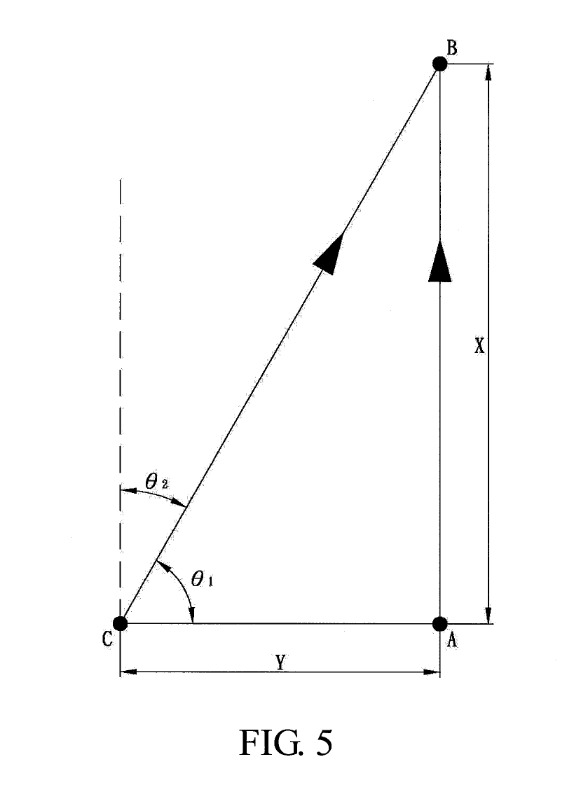

Apart from the aforementioned technical features, in the present preferred embodiment, as shown in FIG. 1, the handheld projector 1 further includes a distance measuring module 14. The distance measuring module 14 is electrically connected to the control module 11. The distance measuring module 14 may be, for example, an infrared signal generating module, which can emit infrared light to the aforementioned object W. Then, after receiving another infrared light reflected by the object W, the distance measuring module 14 can calculate a distance (a projection distance) between the handheld projector 1 and the object W according to the emitted infrared light and the reflected infrared light. Further, the distance measuring module 14 transmits the projection distance to the control module 11, thus the control module 11 can obtain the projection distance. Through the distance measuring module 14, the control module 11 is enabled to accurately control the steering module 13. The principle of controlling the steering module 13 may be referred to FIG. 5. In FIG. 5, it is assumed that the aforementioned handheld projector 1 (shown in FIG. 1) is located at position A, the aforementioned object W is located at position B, the handheld projector 1 projects an image towards the object W (i.e., projecting from position A towards position B), and the distance measuring module 14 can then measure a distance between position A and B as a projection distance X. When the user shifts the handheld projector 1 to position C, then the control module 11 can calculate the distance between position C and B as the distance Y according to a shift signal generated by the steering module 12. Further, the control module 11 obtains a value of a deviation angel θ1 through a mathematical expression “tanθ1=X÷Y ”. Next, the control module 11 obtains a value of a steering angel θ2 through a mathematical expression “θ2=90°-θ1”. Accordingly, the control module 11 can generate a rotation command according to the steering angel θ2, so as to drive the steering module 13 to rotate the projection module 10 with the steering angel θ2 (as shown in FIG. 2) in a clockwise direction. Accordingly, after the handheld projector 1 is shifted to position C, the handheld projector 1 can still project image(s) to position B, thereby achieving an effect of projection image(s) to a fixed position.

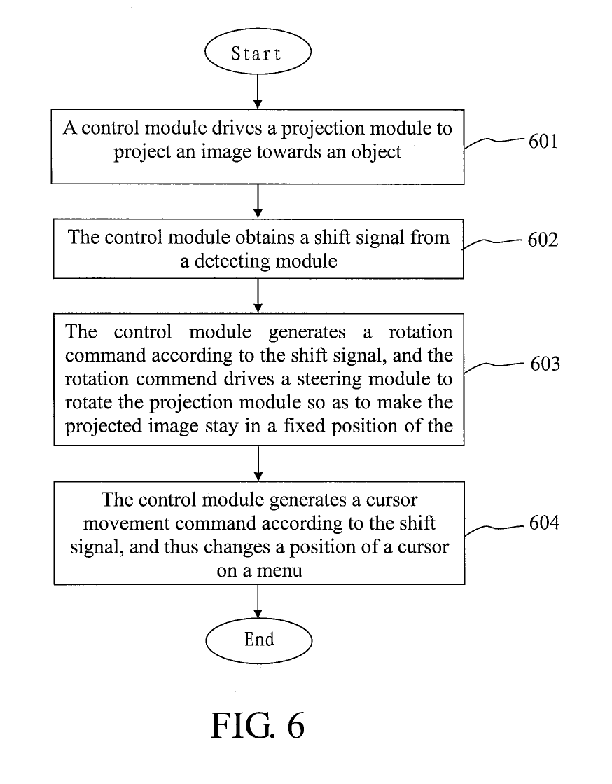

In order for the people with ordinary skill in the art easily understand the technical features of the invention, the operation process of the invention will be illustrated in accordance with flowcharts embodiments of FIG. 1 to FIG. 3 and FIG. 6.

In Step (601), the control module 11 drives the projection module 10 to project the image 3 towards the object W, wherein the image 3 includes the menu 30 and the light cursor 31.

In Step (602), the control module 11 obtains a shift signal from the detecting module 12.

In Step (603), the control module 11 generates a rotation command according to the shift signal to drive the steering module 13 to rotate the projection module 10, so as to make the image 3 projected by the projection module 10 stay in a fixed position of the object W.

In Step (604), the control module 11 generates a light cursor movement command, and then drives the projection module 10 according to the light cursor movement command, so as to change the position of the light cursor 31 on the menu 3 when the image 3 is projected by the projection module 10.

In summary, through the design of the present invention, when the user holds the handheld projector 1 in hand to perform image projection, even when the user accidentally sway the handheld projector 1, the image 3 projected by the handheld projector 1 can stably be projected on a fixed position without any situation of shaking the image 3. Thus, this does not benefit the user and other viewers clearly recognize the image 3, and this can also avoid uncomfortable feeling due to shaking the image 3. Further, the user does not need maintain hand posture thereof and can move the hand during the image projection. Thus, fatigue of the user is effectively reduced. Further, when the user intends to move the light cursor 31 on the menu 30 in the image 3, the user does not need press the button (not shown) on the handheld projector 1 but only needs to move the handheld projector 1 to intuitively complete operation. Accordingly, this greatly lower possibility of the user pressing the button and the manufacturers can omit designing a portion of buttons (e.g., directional button(s)) when designing the handheld projector 1. Thereby, not only hardware structure of the handheld projector 1 can be simplified, which makes the design of the handheld projector 1 simpler but also the manufacturing cost is effectively lowered.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A handheld projector, comprising:
a control module;
a projection module, electrically connected to the control module, wherein the control module is configured to drive the projection module to project an image towards an object, and the image comprises a cursor;
a detecting module, electrically connected to the control module and configured to generate a shift signal according to shift of the handheld projector, and transmit the shift signal to the control module, wherein the control module generates a cursor movement command according to the shift signal to drive the projection module to change a position of the cursor when projecting the image; and
a steering module, respectively and electrically connected to the control module and the projection module, wherein after the control module receives the shift signal, the control module generates a rotation command according to the shift signal, and then transmits the rotation command to the steering module to drive the steering module to rotate the projection module towards an opposite direction of the shift of the handheld projector, so as to make the image projected by the projection module stay in a fixed position of the object.

2. The handheld projector as claimed in claim 1, further comprising a distance measuring module electrically connected to the control module and configured to detect a projection distance between the handheld projector and the object, and then transmit data of the projection distance to the control module.

3. The handheld projector as claimed in claim 2, wherein the control module calculates a shift distance Y of the handheld projector according to the shift signal, calculates a deviation angle θ1 through a first mathematical expression of “tanθ1=X÷Y” according to a projection distance X, and further calculates a steering angle θ2 through a second mathematical expression of “θ2=90°-θ1”, wherein the control module generates the rotation command according to the steering angle θ2, and makes the steering module to rotate the projection module according to the steering angle θ2.

4. The handheld projector as claimed in claim 1, wherein the detecting module is a gyroscope, an accelerometer or a G-Sensor.

5. A projection method of a handheld projector, wherein the handheld projector comprises a projection module, and the projection method comprises:
the projection module projecting an image towards an object, wherein the image comprises a cursor;
obtaining a shift signal according to shift of the handheld projector;
generating a rotation command according to the shift signal for rotating the projection module, so as to make the image projected by the projection module stay in a fixed position of the object; and
generating a cursor movement command according to the shift signal to change a position of the cursor when projecting the image according to the shift signal.

6. The projection method of a handheld projector as claimed in claim 5, further comprising:
obtaining a projection distance between the handheld projector and the object.

7. The projection method of a handheld projector as claimed in claim 6, further comprising:
calculating a displacement distance Y of the handheld projector according to the shift signal;
calculating a deviation angle θ1 according to the projection distance X and a first mathematical expression of “tanθ1=X÷Y”;
calculating a steering angle θ2 according to a second mathematical expression of “θ2=90°-θ1”; and
generating the rotation command according to the steering angle θ2, and rotating the projection module according to the steering angle θ2.
